(19) United States
(12) Patent Application Publication
(10) Pub. No.: US 2026/0260664 A1
(43) Pub. Date: Sep. 3, 2026

(54) SYSTEM AND METHOD FOR AUTOMATED VIDEO DIRECTION USING MULTIMODAL DATA

(71) Applicant: Vizi Inc.

(72) Inventors: Adam James Silver, Baiona (ES); William Bradshaw Pillow, Zionsville, IN (US)

(73) Assignee: Vizi Inc., (US)

(21) Appl. No.: 19/553,434

(22) Filed: Mar. 2, 2026

Related U.S. Application Data
(60) Provisional application No. 63/766,240, filed on Mar. 3, 2025.

(51) Int. Cl. G11B 27/031; G06T 7/246; G11B 27/10

(52) U.S. Cl. CPC G11B 27/031; G06T 7/246; G11B 27/10; G06T 2207/10016

(57) ABSTRACT

Systems and methods for automated creative video direction are disclosed. A communication device receives a plurality of video streams from a plurality of video capture devices and at least one of at least one audio stream and telemetry data from a telemetry data source. A computing device processes the received data to extract at least one of a visual contextual feature, an audio contextual feature, and a telemetry contextual feature, and combines at least two of these features to generate a unified contextual representation of a common real-world occurrence. Based on the unified contextual representation, the computing device determines one or more editorial decisions, including at least one of selecting a video stream for presentation, determining transition timing, selecting a camera angle, or determining a transition behavior. The computing device outputs a directed output video stream by applying the editorial decisions to the plurality of video streams.

### REFERENCE TO RELATED APPLICATIONS

This application claims the benefit of U.S. Provisional Patent Application No. 63/766,240 titled “AI VIDEO CLOUD SERVICE AND MULTI-CAMERA SYSTEM”, filed on 03/03/2025, which is incorporated by reference herein in its entirety.

### TECHNICAL FIELD

The present disclosure relates generally to systems and methods for motion video signal processing for recording or reproducing. More particularly, the disclosure relates to systems for and methods of automated video direction.

### BACKGROUND

The present invention relates generally to the field of multimedia production and, more particularly, to automated systems for directing and producing video content from multiple concurrent media sources. The field of multi-camera video production has become increasingly significant with the proliferation of digital capture devices, live streaming platforms, immersive content formats, and real-time content distribution networks. In a wide range of applications—including athletic performances, live events, concerts, sporting competitions, educational presentations, and user-generated content—multiple video capture devices are deployed to record a common real-world occurrence from different viewpoints. The ability to transform such simultaneous streams into a coherent, engaging, and professionally directed output is of substantial commercial and creative importance. As the volume and accessibility of video capture devices have increased, there is a growing desire to achieve high-quality, dynamically directed video productions without requiring extensive human crews, specialized production equipment, or post-production editing resources. An objective in this field is to facilitate automated creative video direction that can intelligently determine how multiple streams of visual, audio, and contextual data should be assembled into a unified output that reflects the most relevant, engaging, or contextually appropriate perspective at any given moment. Conventional approaches to multi-camera production typically rely on manual direction, wherein a human operator monitors multiple video feeds and makes real-time decisions regarding camera selection, transition timing, and shot composition. Such processes are labor-intensive, require skilled personnel, and may be impractical or cost-prohibitive in many environments. In smaller-scale or consumer contexts, users are often limited to a single viewpoint or must perform time-consuming manual editing after capture to create a compelling final video. Existing automated or semi-automated solutions may provide basic switching functionality or rule-based transitions between streams. However, such approaches frequently lack the ability to consider multiple forms of contextual information simultaneously. For example, systems may be limited to analyzing visual data alone, without incorporating one or more of audio cues, motion-related information, or other contextual indicators that reflect the dynamics of the captured occurrence. As a result, automated decisions may fail to correspond to meaningful changes in action, emphasis, intensity, or audience engagement. Furthermore, synchronizing and correlating multiple heterogeneous data sources such as video streams from different viewpoints, audio streams captured from different locations, and telemetry or environmental data presents technical challenges. Variations in timing, perspective, quality, and contextual relevance across these sources can make it difficult to determine which stream should be emphasized at a particular moment. Without an integrated and context-aware decision framework, automated systems may produce output that appears disjointed, poorly timed, or aesthetically inconsistent. In addition, in dynamic environments where events evolve rapidly over time, editorial decisions must adapt continuously to reflect changes in activity, emphasis, or viewer interest. Systems that do not account for the temporal evolution of contextual factors may be unable to update presentation decisions responsively, resulting in missed highlights or suboptimal transitions between viewpoints.

Accordingly, there remains a need in the field of multimedia production for improved systems and methods for facilitating automated creative video direction that can overcome one or more of the preceding problems.

### SUMMARY

The present disclosure provides systems and methods for automated creative video direction in which a communication device receives multimodal data from external capture devices, and a computing device determines editorial decisions based on contextual interpretation of two or more of visual data, audio data, and telemetry data associated with a common real-world occurrence.

In accordance with one aspect of the disclosure, a system for automated creative video direction comprises a communication device and a computing device. The communication device is configured to receive a plurality of video streams from a plurality of video capture devices external to the system, and at least one of at least one audio stream and telemetry data from a telemetry data source external to the system. The video capture devices capture visual data of a common real-world occurrence from different viewpoints, the captured visual data forming the plurality of video streams.

The communication device provides the received data to the computing device. The computing device processes the received data to extract at least one of a visual contextual feature, an audio contextual feature, and a telemetry contextual feature. The computing device combines at least two of the visual contextual feature, the audio contextual feature, and the telemetry contextual feature to generate a unified contextual representation of the real-world occurrence.

Based on the unified contextual representation, the computing device determines one or more editorial decisions, including at least one of selecting a video stream for presentation, determining a time at which to transition between video streams, selecting a camera angle associated with a selected video stream, or determining a transition behavior between video streams. The computing device then outputs a directed output video stream by applying the determined editorial decisions to the plurality of video streams.

Advantageously, the editorial decisions are determined based on contextual interpretation of two or more of visual, audio, and telemetry data rather than analysis of video streams alone, enabling automated video direction that more accurately reflects the evolving context of the real-world occurrence.

### BRIEF DESCRIPTION OF THE DRAWINGS

The detailed description of the present invention is described with reference to the accompanying figures. Same numbers are used throughout the drawings to reference like features and components.

FIG. 1 illustrates a system for automated creative video direction comprising a communication device, a computing device, and an output component, with external video capture devices, at least one audio capture device, and at least one telemetry data source communicatively coupled to the system via the communication device, in accordance with some embodiments.

FIG. 2A illustrates extraction of a visual contextual feature from video streams, in accordance with some embodiments.

FIG. 2B illustrates extraction of an audio contextual feature from audio streams, in accordance with some embodiments.

FIG. 2C illustrates extraction of a telemetry contextual feature from telemetry data, in accordance with some embodiments.

FIG. 3 illustrates generation of a unified contextual representation by combining at least two of a visual contextual feature, an audio contextual feature, and a telemetry contextual feature, and determination of editorial decisions based on the unified contextual representation, in accordance with some embodiments.

FIG. 4 illustrates a method 500 for automated video direction, in accordance with some embodiments.

### DETAILED DESCRIPTION

The following detailed description is provided to illustrate representative embodiments of the present disclosure and is not intended to limit the scope of the invention, which is defined by the appended claims. The embodiments described herein may be implemented in a variety of forms, and the disclosure is not limited to the specific embodiments, structures, or configurations described.

As used herein, the singular forms “a,” “an,” and “the” include plural referents unless the context clearly indicates otherwise. The terms “comprising,” “including,” and “having” are used in an open-ended sense and do not exclude additional elements or steps not expressly recited.

The term “or,” as used herein, is inclusive, meaning “and/or,” unless the context clearly indicates otherwise. The terms “based on” and “responsive to” are used to indicate that a feature, determination, or operation is at least partially dependent on the referenced input or condition, and do not require exclusive dependence unless expressly stated.

As used herein, a “computing device” refers to one or more processing devices configured to execute instructions stored on one or more non-transitory computer-readable media. A computing device may include general-purpose processors, special-purpose processors, or a combination thereof, and may be implemented as a single physical device or as a distributed computing system.

The term “video stream” refers to a sequence of visual data captured over time by a video capture device, whether continuous or segmented, and regardless of encoding format. The term “audio stream” refers to audio data captured over time by an audio capture device. The term “telemetry data” refers to data sensed by one or more telemetry data sources and associated with a real-world occurrence, including, but not limited to, motion data, inertial data, location data, biometric data, or environmental data.

As used herein, the term “editorial decision” refers to a decision relating to presentation of captured visual data, including, without limitation, selection of a video stream for presentation, determination of when to transition between video streams, selection of a camera angle associated with a video stream, or determination of a transition behavior between video streams. Editorial decisions are distinguished from data acquisition operations performed by capture devices.

The term “directed output video stream” refers to an output video stream generated by applying one or more editorial decisions to a plurality of video streams, resulting in a selected and directed presentation of a common real-world occurrence.

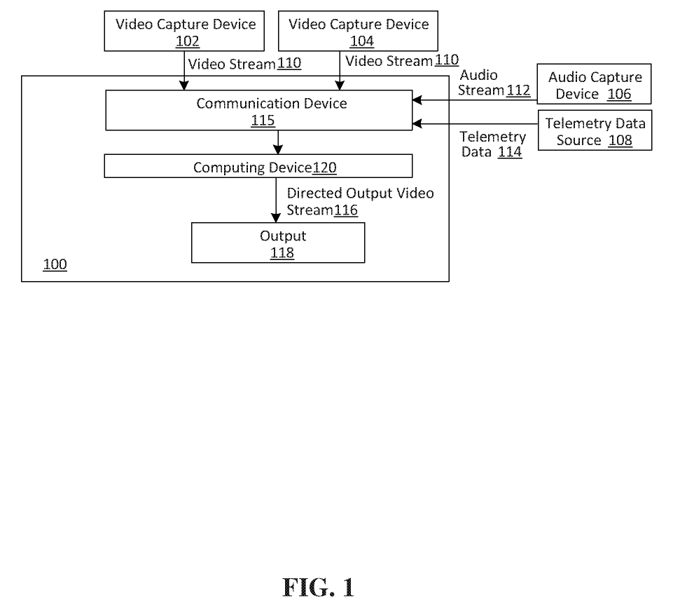

Unless expressly stated otherwise, the steps of the methods described herein are not required to be performed in the order shown, and steps may be combined, omitted, or performed in different orders consistent with the appended claims. Representative embodiments of the system architecture and data capture components is described with reference to FIG. 1.

Referring to FIG. 1, an example system 100 for automated video direction is illustrated. The system 100 is configured to generate a directed output video stream 116 from a plurality of video streams 110 captured by multiple video capture devices, based on combined analysis of visual data, audio data, and telemetry data associated with a common real-world occurrence.

As used herein, a “common real-world occurrence” refers to a physical occurrence that unfolds over time and space and is simultaneously observable by multiple sensing devices. Examples include, without limitation, sporting events, races, performances, competitive or cooperative activities involving multiple participants, training sessions, demonstrations, or other physical activities that can be captured from multiple viewpoints.

The system 100 comprises a communication device 115, a computing device 120, and an output component 118. The communication device 115 is configured to receive a plurality of video streams 110 from a plurality of video capture devices 102 and 104 external to the system 100, and at least one of at least one audio stream 112 and telemetry data 114 from external sources. The plurality of video capture devices 102, 104, at least one audio capture device 106, and at least one telemetry data source 108 are external to the system 100 and communicatively coupled to the communication device 115. The video capture devices 102, 104 are configured to capture visual data of the common real-world occurrence from different viewpoints. Each video capture device may be positioned at a distinct spatial location relative to the occurrence, may have a different field of view, orientation, focal length, or mounting configuration, and may capture different visual perspectives of the occurrence.

In various implementations, the video capture devices 102, 104 may include fixed-position cameras, handheld cameras, wearable cameras, vehicle-mounted cameras, drone-mounted cameras, robotic cameras, or cameras integrated into mobile devices. The disclosure does not require that the video capture devices be homogeneous, and different video capture devices may have different capabilities, resolutions, frame rates, or optical characteristics.

Each video capture device generates captured visual data that forms a corresponding video stream 110. The video streams 110 may be continuous streams or segmented streams, and may be encoded using any suitable video encoding format. The system does not require that all video streams have identical frame rates, resolutions, or encoding parameters.

The video capture devices 102, 104 are not required to perform editorial decision-making, camera switching, or stream selection. In the illustrated system 100, the video capture devices function primarily as data acquisition components that provide visual data to the computing device 120. The audio capture device 106 is configured to capture audio data associated with the common real-world occurrence. The captured audio data forms at least one audio stream 112.

The audio capture device 106 may include one or more microphones, microphone arrays, directional microphones, wearable microphones, vehicle-mounted microphones, or other audio sensing components. In some embodiments, multiple audio capture devices may be deployed at different locations relative to the occurrence, and the resulting audio data may be combined into a single audio stream 112 or provided as multiple audio streams.

The audio stream 112 may include ambient sounds, participant-generated sounds, mechanical sounds, environmental sounds, or other audio signals associated with the occurrence. The system does not require that the audio stream include speech, nor does it require speech recognition or audio transcription.

The audio capture device 106 functions as a data acquisition component and does not determine editorial decisions. The audio stream 112 is provided to the communication device 115 for forwarding to the computing device 120. The telemetry data source 108 is configured to sense telemetry data 114 associated with the common real-world occurrence. The telemetry data 114 may include, without limitation, motion data, inertial data, location data, biometric data, or environmental data.

In representative embodiments, telemetry data sources 108 may include sensors integrated into participants, vehicles, equipment, wearable devices, mobile devices, or infrastructure associated with the occurrence. Telemetry data may be generated continuously, periodically, or in response to detected events.

Examples of telemetry data include speed measurements, acceleration measurements, orientation measurements, geographic position data, heart rate data, exertion indicators, temperature measurements, vibration measurements, or environmental condition measurements. The telemetry data 114 may be time-stamped or otherwise associated with temporal information.

The telemetry data source 108 is distinct from the video capture devices 102, 104, and the audio capture device 106, and is external to the system 100. The telemetry data 114 is provided as a separate data input to the communication device 115 and is not derived solely from analysis of video or audio data. The communication device 115 is configured to receive the plurality of video streams 110 and at least one of the at least one audio stream 112 and the telemetry data 114. The communication device 115 may receive the data via wired or wireless communication links, local interfaces, network connections, or combinations thereof, and provide the received data to the computing device 120.

The communication device 115 may receive the video streams 110, audio stream 112, and telemetry data 114 in real time during capture of the common real-world occurrence, or may receive previously captured data for subsequent processing. The disclosure does not require a particular timing relationship among the received data, although temporal information may be associated with the data to support subsequent processing.

The computing device 120 may be implemented as a single physical device or as a logical computing system comprising multiple processing resources. The computing device may be implemented on a mobile device, an edge computing device, a server, a cloud-based platform, or any combination thereof, consistent with dependent claim limitations. Based on processing performed by the computing device 120, a directed output video stream 116 is generated. The directed output video stream 116 reflects editorial decisions applied to the plurality of video streams 110 and represents a selected and directed presentation of the common real-world occurrence.

The directed output video stream 116 may be provided to an output component 118, which may include a display device, a storage system, a streaming platform, a broadcast encoder, or another distribution mechanism. The directed output video stream 116 may be stored for later playback, transmitted to viewers in real time, or used for further processing. A key aspect of the system 100 is the separation between data capture and editorial direction. The video capture devices 102, 104, audio capture device 106, and telemetry data source 108 operate independently to acquire data associated with the common real-world occurrence. Editorial decisions regarding selection and presentation of video streams are determined by the computing device 120 based on combined analysis of the received data, rather than by individual capture devices acting independently.

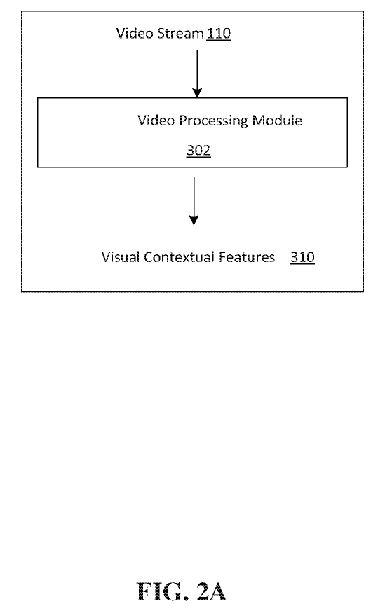

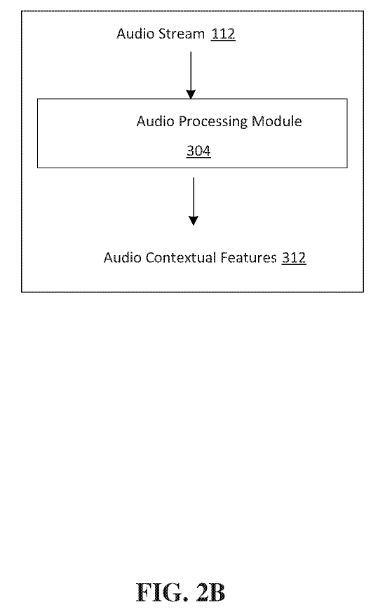

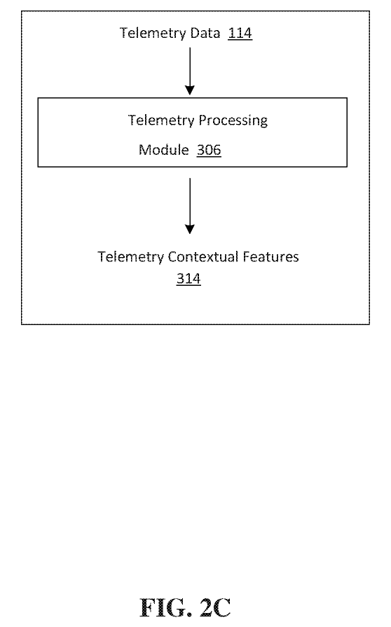

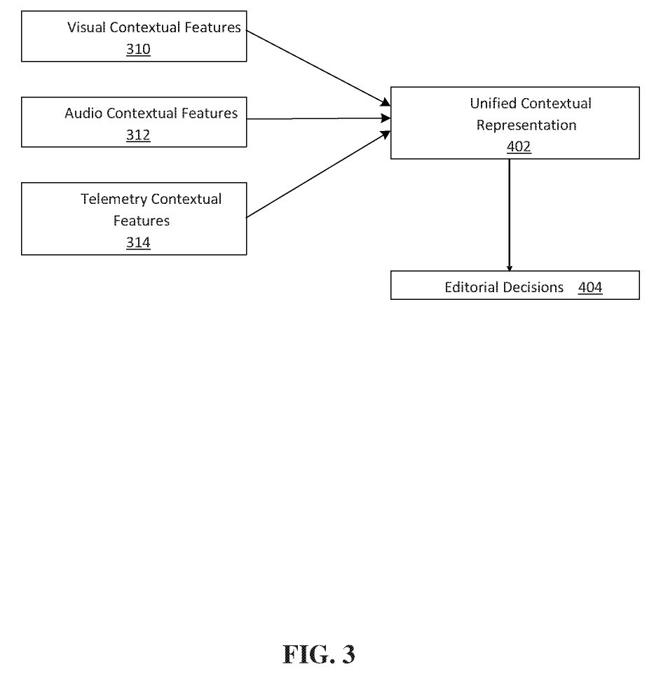

This separation enables scalable deployment of the system across a wide range of capture configurations and use cases, while allowing the computing device 120 to determine editorial decisions based on a holistic understanding of the occurrence derived from multiple data sources. Referring to FIGS. 2A-2C and FIG. 3, the computing device 120 is configured to process the plurality of video streams 110, the at least one audio stream 112, and the telemetry data 114 to extract corresponding contextual features, and to combine those contextual features to generate a unified contextual representation of the common real-world occurrence.

In the embodiments described herein, contextual features are derived representations of captured data that characterize aspects of the real-world occurrence reflected in the captured data. Contextual features are not limited to a particular representation format and may include numerical values, vectors, event indicators, or other data structures suitable for subsequent combination and analysis. As shown in FIG. 2A, the plurality of video streams 110 is processed by a video processing module 302 to extract visual contextual features 310.

The video processing module 302 may operate on individual video streams independently or may process multiple video streams jointly. The processing may include analysis of frame-to-frame changes, spatial characteristics, temporal patterns, or other properties observable within the video streams over time. The disclosure does not require a particular video analysis technique, and different embodiments may employ different approaches consistent with the appended claims.

In some implementations, visual contextual features 310 may be derived from detected changes within the video streams over time, such as changes in motion patterns, changes in relative positions of observed elements, changes in camera viewpoint content, or changes in visual activity levels. In other implementations, visual contextual features may be derived from higher-level representations generated from the video streams.

Importantly, the visual contextual features 310 are extracted for the purpose of contributing to a combined understanding of the common real-world occurrence. The extraction of visual contextual features does not itself determine editorial decisions, and does not require ranking or selecting video streams at this stage. Also shown in FIG. 2B, the at least one audio stream 112 is processed by an audio processing module 304 to extract audio contextual features 312.

The audio processing module 304 may analyze the audio stream to detect variations, patterns, or events within the audio data over time. Such processing may include, without limitation, analysis of amplitude changes, frequency content changes, temporal patterns, or detected audio events. The disclosure does not require that the audio processing module perform speech recognition or semantic interpretation, although such techniques may be used in some embodiments.

Audio contextual features 312 may represent, for example, changes in sound intensity, sudden audio events, sustained audio patterns, or other characteristics indicative of developments in the real-world occurrence. The audio contextual features are extracted independently of the visual contextual features and are not limited to audio associated with any particular video stream.

The audio contextual features 312 are generated as a separate output of the audio processing module 304 and are provided for subsequent combination with other contextual features. Further shown in FIG. 2C, the telemetry data 114 is processed by a telemetry processing module 306 to extract telemetry contextual features 314.

The telemetry processing module 306 may analyze telemetry data to identify changes, events, or patterns reflected in the sensed data. Telemetry contextual features 314 may include representations of changes in motion state, changes in measured parameters, detected thresholds, or other telemetry-derived indicators associated with the common real-world occurrence.

In some embodiments, telemetry contextual features may be derived from motion data, inertial data, location data, biometric data, environmental data, or combinations thereof. The telemetry contextual features 314 are generated independently of the visual and audio contextual features and are not derived solely from analysis of video or audio data.

The separation of telemetry processing from video and audio processing allows telemetry data to influence subsequent editorial decisions even in circumstances where visual or audio changes are subtle or ambiguous. As illustrated in FIGS. 2A-2C, the video processing module 302, audio processing module 304, and telemetry processing module 306 operate as distinct processing components that generate corresponding contextual feature outputs 310, 312, and 314.

This separation ensures that contextual features derived from different data modalities are preserved as independent inputs prior to combination. The disclosure does not require that the contextual features be generated using the same sampling rate, representation format, or processing technique, provided that the features can be associated for subsequent combination.

The separation of feature extraction across modalities supports flexibility in system implementation and avoids imposing a particular processing architecture or algorithmic approach. Referring now to FIG. 3, the visual contextual features 310, audio contextual features 312, and telemetry contextual features 314 are combined to generate a unified contextual representation 402 of the common real-world occurrence.

The unified contextual representation 402 is generated by associating the contextual features derived from different modalities based on temporal correspondence and other relationships. In some embodiments, the combination may involve aligning contextual features according to time information associated with the underlying data, such that features corresponding to the same time intervals or events are associated.

The unified contextual representation 402 may be represented as a data structure that captures the state of the common real-world occurrence as reflected collectively by the visual, audio, and telemetry contextual features. The disclosure does not require a particular representation format, and the unified contextual representation may take various forms depending on the implementation. The unified contextual representation 402 serves as an intermediate representation that enables editorial decisions to be determined based on combined interpretation of multiple data sources. Rather than making editorial decisions based solely on video data, the computing device 120 relies on the unified contextual representation to incorporate information reflected in audio and telemetry data.

By generating the unified contextual representation 402 prior to determining editorial decisions, the system separates the tasks of feature extraction, feature combination, and editorial decision determination. This separation improves modularity and allows different feature extraction or combination techniques to be used without altering the fundamental editorial decision framework defined in the claims. Once the unified contextual representation 402 is generated, it is provided as input to the editorial decision determination stage. At this point, the computing device 120 has access to a combined representation reflecting visual, audio, and telemetry aspects of the common real-world occurrence.

The unified contextual representation 402 does not itself prescribe editorial outcomes. Instead, it provides a structured basis upon which the computing device determines editorial decisions, including selection of video streams, determination of transition timing, selection of a camera angle, and determination of transition behavior. Referring to FIG. 3, the computing device 120 is configured to determine one or more editorial decisions 404 based on the unified contextual representation 402 of the common real-world occurrence.

As described in Claim 1, editorial decisions may include, without limitation, selecting a video stream from the plurality of video streams for presentation, determining a time at which to transition between video streams, selecting a camera angle or perspective associated with a selected video stream, and determining a transition behavior between successive video streams. As described in the claims, editorial decisions may include, without limitation, selecting a video stream from the plurality of video streams for presentation, determining a time at which to transition between video streams, selecting a camera angle associated with a selected video stream, and determining a transition behavior between successive video streams.

In the disclosed system, editorial decisions are not determined directly from individual video streams, audio streams, or telemetry data in isolation. Instead, editorial decisions are determined based on the unified contextual representation 402, which reflects combined interpretation of visual contextual features 310, audio contextual features 312, and telemetry contextual features 314. Editorial decisions, as used herein, refer to decisions that govern how captured visual data is presented over time in the directed output video stream 116. Editorial decisions are distinct from data acquisition, data encoding, or data transmission operations, and are concerned with selection, timing, and presentation of visual content.

Editorial decisions determined by the computing device 120 may be discrete decisions made at specific times or may be continuously updated decisions that evolve as the unified contextual representation 402 changes over time.

The disclosure does not require that editorial decisions correspond to predefined shot types, camera rankings, or fixed rules. Rather, editorial decisions are determined based on the state of the unified contextual representation at a given time. In some embodiments, determining editorial decisions 404 includes selecting a video stream from the plurality of video streams 110 for presentation in the directed output video stream 116.

The selection of a video stream is based on the unified contextual representation 402 and may reflect combined information derived from visual, audio, and telemetry contextual features. For example, changes reflected in telemetry contextual features or audio contextual features may influence selection of a video stream even when visual differences among video streams are minimal.

The computing device 120 may determine to maintain presentation of a currently selected video stream, or to switch to a different video stream, based on changes in the unified contextual representation over time. In addition to selecting a video stream, determining editorial decisions 404 may include determining a time at which to transition between video streams of the plurality of video streams 110.

Transition timing decisions govern when a switch between video streams occurs in the directed output video stream 116. Such decisions may take into account temporal aspects of the unified contextual representation 402, including the onset, duration, or cessation of features reflected in the combined contextual features.

By determining transition timing based on the unified contextual representation rather than on video data alone, the system may avoid abrupt or poorly timed transitions that do not align with the significance of events occurring in the real-world occurrence. In some embodiments, determining editorial decisions 404 includes selecting a camera angle associated with a selected video stream.

A camera angle may refer to a particular viewpoint, framing, or orientation associated with a video capture device. Selection of a camera angle may involve choosing among available viewpoints provided by the video capture devices or choosing among different angles or perspectives associated with a single video capture device.

The selection of a camera angle is based on the unified contextual representation 402 and may reflect information derived from multiple modalities. For example, telemetry contextual features indicating changes in motion or position may influence the selection of a camera angle that better reflects the current state of the occurrence. Editorial decisions 404 may further include determining a transition behavior between successive video streams.

Transition behavior refers to how a transition between video streams is presented in the directed output video stream 116. Examples of transition behavior include immediate cuts, gradual transitions, or other presentation behaviors. The disclosure does not require a particular transition style, and different embodiments may employ different transition behaviors.

Determination of transition behavior based on the unified contextual representation 402 allows the system to adapt how transitions are presented in a manner consistent with the evolving context of the occurrence. Editorial decisions 404 may be updated over time as the unified contextual representation 402 changes. The computing device 120 may continuously or periodically re-evaluate the unified contextual representation and update editorial decisions accordingly.

This temporal evolution allows the directed output video stream 116 to reflect changes in the common real-world occurrence as they occur, without requiring manual intervention. A distinguishing aspect of the disclosed system is that editorial decisions are determined based on contextual interpretation of combined visual, audio, and telemetry data rather than analysis of video streams alone.

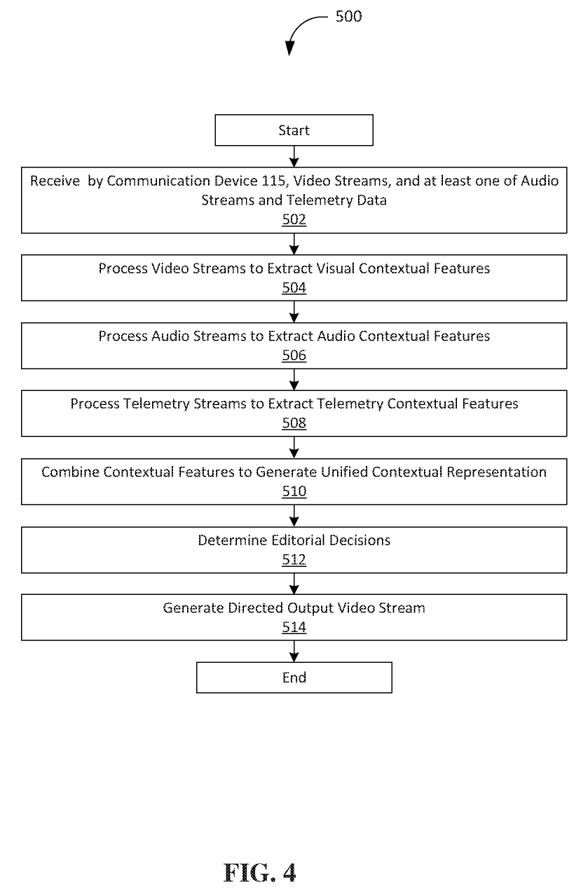

Referring to FIG. 4, the method 500 includes receiving, by a communication device, a plurality of video streams and at least one of at least one audio stream and telemetry data (step 502), processing the video streams to extract a visual contextual feature (step 504), processing the at least one audio stream to extract an audio contextual feature (step 506), processing the telemetry data to extract a telemetry contextual feature (step 508), combining at least two of the visual contextual feature, the audio contextual feature, and the telemetry contextual feature to generate a unified contextual representation (step 510), determining editorial decisions based on the unified contextual representation (step 512), and outputting a directed output video stream by applying the editorial decisions to the plurality of video streams (step 514).

Systems that select video streams based solely on video characteristics, such as motion magnitude or frame composition, are fundamentally different from the disclosed system, which incorporates information reflected in audio and telemetry data into the editorial decision process. Once editorial decisions 404 are determined, the computing device 120 applies the editorial decisions to the plurality of video streams to generate the directed output video stream 116. Referring to FIG. 1 and FIG. 4, once the computing device 120 determines one or more editorial decisions 404 based on the unified contextual representation 402, the computing device applies those editorial decisions to the plurality of video streams 110 to generate a directed output video stream 116.

The directed output video stream 116 represents a selected and directed presentation of the common real-world occurrence and reflects the editorial decisions determined by the computing device 120 over time. The directed output video stream may be generated during capture of the occurrence, after capture of the occurrence, or using a combination of real-time and post-processing techniques. Applying editorial decisions to the plurality of video streams 110 may include selecting video content from one or more video streams, ordering selected video content in time, and applying transitions between selected video content in accordance with the determined editorial decisions.

In some embodiments, the computing device 120 selects portions of video streams corresponding to the determined editorial decisions and concatenates or otherwise assembles the selected portions to form the directed output video stream 116. In other embodiments, the computing device 120 controls a switching or routing mechanism that selects which video stream is provided as output at a given time.

The disclosure does not require that the directed output video stream be formed by modifying the underlying video streams. Rather, the directed output video stream may be generated by selecting among existing video streams and controlling how those streams are presented. In some embodiments, the computing device 120 generates the directed output video stream 116 during capture of the common real-world occurrence. In such embodiments, editorial decisions may be determined and applied in real time or near real time as the video streams 110, audio stream 112, and telemetry data 114 are received.

Real-time operation allows the system to support live viewing, live broadcasting, or live streaming of the directed output video stream. The system may update editorial decisions dynamically as the unified contextual representation 402 changes, allowing the directed output video stream to adapt to unfolding events.

The disclosure does not require a specific latency threshold, and the degree of real-time operation may vary depending on system implementation and use case. In other embodiments, the computing device 120 generates the directed output video stream 116 after capture of the common real-world occurrence. In such embodiments, the video streams 110, audio stream 112, and telemetry data 114 may be stored and processed at a later time to determine editorial decisions and generate the directed output video stream.

Post-processing operation allows the system to be used in scenarios where immediate output is not required, such as generating highlight reels, summaries, or edited recordings. The editorial decision framework described herein applies equally to real-time and non-real-time operation. The system may operate in environments where video streams, audio streams, and telemetry data are not perfectly synchronized or are subject to varying availability. The computing device 120 may receive data from different sources at different times and may process available data as it is received.

In some embodiments, editorial decisions may be determined based on a subset of available data when other data is delayed or temporarily unavailable. For example, editorial decisions may be updated when telemetry data becomes available after a delay, or may be determined based on video and audio data when telemetry data is temporarily unavailable.

The disclosure does not require that all data be continuously available for the system to operate. The directed output video stream 116 generated by the computing device 120 may be provided to an output component 118. The output component 118 may include a display device for viewing by one or more users, a storage system for storing the directed output video stream, a streaming service for distributing the directed output video stream, or a broadcast system for transmitting the directed output video stream.

The directed output video stream 116 may be encoded, packaged, or otherwise prepared for distribution using techniques known in the art. The disclosure does not require a particular distribution mechanism. In some embodiments, the directed output video stream 116 is stored in memory for subsequent playback. Stored directed output video streams may be accessed for later viewing, analysis, or distribution.

Storage of the directed output video stream allows the system to support use cases such as on-demand viewing, replay, or archival of automatically directed video content. During runtime operation, the computing device 120 may adapt its behavior based on changes in the unified contextual representation 402. For example, the computing device may adjust how frequently editorial decisions are updated, how long a selected video stream is maintained before transitioning, or how transitions are applied.

Such runtime adaptability allows the directed output video stream to reflect the evolving nature of the common real-world occurrence without requiring manual intervention.

The system and method embodiments described herein may be implemented independently or in combination, and the disclosure is not limited to a particular sequence of operations except as recited in the appended claims. The following worked examples are non-limiting and provided to illustrate how the systems and methods described herein operate in concrete, real-world scenarios. These examples demonstrate how editorial decisions are determined based on combined analysis of visual data, audio data, and telemetry data associated with a common real-world occurrence, and how the unified contextual representation enables automated video direction that reflects the evolving state of the occurrence.

Consider a motorsport racing event conducted on a closed racing circuit. Multiple vehicles participate simultaneously, and the event unfolds continuously over time with rapidly changing conditions. The racing environment includes multiple sources of visual data, audio data, and telemetry data. The common real-world occurrence in this example is the racing event itself, including vehicle movement, competitive interactions, and track activity. In this example, a plurality of video capture devices are deployed, including:

Onboard cameras mounted on multiple racing vehicles, capturing forward-facing and rear-facing views. Trackside cameras positioned at various points along the circuit, capturing wide-angle and close-up views of different track segments. Overhead or aerial cameras capturing broader perspectives of vehicle groupings and track dynamics. Pit lane cameras capturing activity during pit stops. Each video capture device captures visual data from a distinct viewpoint, forming a corresponding plurality of video streams.

At least one audio capture device captures audio data associated with the racing event. Audio sources may include: Engine sounds from vehicles; Tire noise, braking sounds, and acceleration sounds; Radio communications (if available); Ambient crowd noise; Environmental sounds such as wind or rain. The captured audio data forms at least one audio stream associated with the racing event.

Telemetry data sources sense telemetry data associated with the racing event. Telemetry data may include, for example: Vehicle speed and acceleration, Brake pressure and throttle position, Steering angle, Gear selection, Vehicle position on the track, Lap timing data, and Tire condition indicators, Environmental telemetry such as track temperature or surface conditions. Telemetry data is generated continuously during the event and is associated with time information.

The computing device receives the plurality of video streams, the audio stream, and the telemetry data. Visual contextual features are extracted from the video streams, reflecting changes in visual activity, vehicle proximity, and movement patterns. Audio contextual features are extracted from the audio stream, reflecting changes in sound intensity, sudden audio events, or sustained audio patterns. Telemetry contextual features are extracted from telemetry data, reflecting changes in vehicle dynamics, speed differentials, braking events, or positional changes.

These contextual features are combined to generate a unified contextual representation of the racing event. The unified contextual representation reflects the evolving state of the race as a whole, rather than isolated observations from individual data sources.

Based on the unified contextual representation, the computing device determines editorial decisions over time. For example, When telemetry data indicates rapid deceleration and lateral movement of a vehicle approaching a corner, combined with visual contextual features indicating proximity between vehicles, the computing device may determine to select a trackside camera view that captures the interaction. Further, when audio contextual features indicate a sudden increase in engine noise combined with telemetry data indicating acceleration, the computing device may maintain an onboard camera view during an overtaking maneuver. In another embodiment, when telemetry data indicates a vehicle entering the pit lane, combined with visual contextual features indicating pit activity, the computing device may transition to a pit lane camera. Importantly, these editorial decisions are not based on video data alone. Telemetry and audio data influence both camera selection and transition timing, enabling editorial decisions that reflect the significance of events even when visual cues alone might be ambiguous. The computing device applies the determined editorial decisions to the plurality of video streams to generate a directed output video stream. The directed output video stream presents a coherent and contextually relevant depiction of the race, automatically transitioning between camera views as the race unfolds. The directed output video stream may be generated in real time for live viewing or stored for later playback.

In another embodiment, consider a multi-participant competitive event involving multiple participants moving within a shared physical environment, such as a team sport, a training exercise, or a multiplayer physical competition. The common real-world occurrence includes interactions among participants, movement patterns, and dynamic changes in activity. Multiple video capture devices capture visual data from different viewpoints, including wide-angle views of the playing area and participant-centric views. Audio capture devices capture ambient sounds, participant communications, or impact sounds. Telemetry data sources may include wearable sensors that provide motion data, biometric data, or location data for individual participants. The computing device processes video, audio, and telemetry data to extract contextual features and generate a unified contextual representation that reflects group dynamics, movement intensity, and changes in participant activity.

For example, telemetry data indicating increased exertion combined with visual contextual features indicating convergence of participants may reflect a high-activity moment. Audio contextual features indicating sudden sound changes may further reinforce the significance of the moment. Based on the unified contextual representation, the computing device determines editorial decisions such as selecting camera views that best reflect group interactions, determining when to transition between wide-angle and participant-focused views, and adjusting transition behavior based on the pace of activity. The system operates without requiring manual intervention, enabling automated direction even in complex multi-participant environments.

In some embodiments, machine learning models may be used to perform portions of feature extraction. For example, a trained machine learning model may process video streams to generate visual contextual features. In another case, a trained model may process audio streams to generate audio contextual features. Also, a trained model may process telemetry data to generate telemetry contextual features. In some embodiments, the computing device may use trained machine learning models to assist in determining editorial decisions based on the unified contextual representation. For example, a model may output decision indicators corresponding to camera selection or transition timing.

In some embodiments, large language models or similar systems may be used to assist in interpreting high-level patterns reflected in the unified contextual representation, such as generating metadata, summaries, or commentary alignment.

The extraction of visual contextual features, audio contextual features, and telemetry contextual features may be implemented using a variety of techniques.

In some embodiments, contextual features may be extracted using deterministic processing techniques, such as threshold-based detection, signal transformation, or pattern matching applied to captured data. In other embodiments, contextual features may be extracted using statistical or probabilistic techniques.

The disclosure does not require that contextual features be extracted using any particular algorithmic approach, provided that the extracted features reflect characteristics of the captured data suitable for subsequent combination and editorial decision determination. In some embodiments, one or more machine learning models may be used to assist in extracting contextual features from captured data. For example, A trained machine learning model may process video streams to generate visual contextual features indicative of observed changes within the video streams. A trained machine learning model may process audio streams to generate audio contextual features indicative of changes or events reflected in the audio data. A trained machine learning model may process telemetry data to generate telemetry contextual features indicative of changes in sensed parameters.

Such models may include, without limitation, neural networks, convolutional architectures, recurrent architectures, transformer-based architectures, or other trained models. The use of machine learning models for feature extraction is optional and does not limit the scope of the claimed invention.

The combination of visual contextual features, audio contextual features, and telemetry contextual features to generate a unified contextual representation may be implemented using rule-based techniques, learned techniques, or combinations thereof.

In some embodiments, contextual features may be associated based on temporal correspondence using predefined rules. In other embodiments, a trained model may be used to generate the unified contextual representation from the contextual features.

The unified contextual representation may be represented as a vector, a set of indicators, a structured data object, or other data structure suitable for editorial decision determination. In some embodiments, the determination of editorial decisions based on the unified contextual representation may be assisted by one or more trained machine learning models.

For example, a trained model may receive the unified contextual representation as input and output decision indicators corresponding to selection of a video stream, determination of transition timing, selection of a camera perspective, or determination of transition behavior.

The trained model may be updated over time based on training data, simulated data, or observed outcomes. The use of machine learning to assist editorial decision determination is optional and does not alter the fundamental editorial decision framework defined in the claims.

In some embodiments, language models or similar systems may be used to assist in higher-level interpretation or augmentation of the automated video direction process.

For example, a language model may be used to: generate metadata describing segments of the directed output video stream, assist in generating commentary or annotations aligned with editorial decisions, interpret symbolic or textual telemetry inputs associated with the common real-world occurrence.

Such use of language models is auxiliary and does not replace or redefine the editorial decision determination based on the unified contextual representation. The claims do not require the use of language models.

In embodiments employing trained models, training may occur offline, online, or using a combination of techniques. Training data may include previously captured video, audio, and telemetry data, simulated data, or annotated examples.

Importantly, the system is not required to be trained for a specific type of occurrence in order to operate. The system may be configured to operate across different types of real-world occurrences using the same underlying editorial decision framework. In some embodiments, the system may adaptively adjust its operation based on availability of data or processing resources. For example, if telemetry data is temporarily unavailable, editorial decisions may be determined based on available visual and audio contextual features, without departing from the overall framework described herein. Such adaptability does not require modification of the claims and illustrates robustness of the disclosed system.

The systems and methods described herein are not limited to any particular number or arrangement of video capture devices, audio capture devices, or telemetry data sources. In various embodiments, the number of capture devices may vary depending on the size, complexity, or nature of the common real-world occurrence.

For example, some embodiments may include only two video capture devices, while other embodiments may include dozens or hundreds of video capture devices capturing different viewpoints. Similarly, one or more audio capture devices and one or more telemetry data sources may be used, and such devices may be added or removed without departing from the scope of the claims.

The video streams, audio streams, and telemetry data described herein may have different resolutions, sampling rates, formats, or encoding schemes. The computing device may process heterogeneous data streams without requiring normalization at the capture stage.

In some embodiments, data may be compressed, encrypted, or otherwise transformed prior to reception by the computing device. Such transformations do not alter the fundamental operation of the system as claimed.

Although the figures depict functional modules for clarity, the disclosure does not require that the processing operations be implemented as distinct software modules or hardware components. In practice, multiple processing operations may be combined, divided, or reordered, provided that the computing device performs the functions recited in the claims.

For example, feature extraction and combination operations may be implemented using shared processing resources, pipelined processing stages, or distributed execution across multiple processors. These variations are within the scope of the appended claims.

Editorial decisions determined by the computing device may be applied in different ways to generate the directed output video stream. In some embodiments, editorial decisions may be applied continuously, while in other embodiments, editorial decisions may be applied at discrete intervals.

The duration for which a selected video stream is maintained, the frequency of transition evaluation, and the manner in which transitions are applied may vary based on implementation or configuration parameters.

The systems and methods described herein may be applied to a wide range of domains beyond the specific examples. These domains may include, without limitation, sports broadcasting, motorsports, training simulations, live events, surveillance review, collaborative activities, performance analysis, and other scenarios involving capture of a common real-world occurrence from multiple viewpoints.

In some embodiments, a technical problem addressed by the disclosure may include that concurrently captured video streams, audio streams, and telemetry streams associated with a common real-world occurrence may be heterogeneous in sampling rate, clock domain, codec format, packetization, capture latency, and content salience, such that naïve alignment and selection may produce perceptible discontinuities, mis-synchronized cuts, or contextually incorrect editorial decisions. In some embodiments, the system may improve multi-stream synchronization technology by implementing a multimodal temporal alignment layer that may establish a shared timeline across sources using one or more of timestamp reconciliation, drift estimation, and content-derived anchors. In some embodiments, timestamp reconciliation may be performed by estimating per-source clock offsets and drift parameters and applying a piecewise-linear or Kalman-filter-based correction to map each source into a global timebase. In some embodiments, content-derived anchors may include detecting common transient events that appear across modalities, such as abrupt acoustic onsets, impulsive motion signatures in inertial telemetry, or high-energy optical flow peaks in video, and then solving a constrained optimization problem that may minimize cross-source anchor misalignment subject to monotonicity and bounded warp constraints. In some embodiments, for live event scenarios, the alignment layer may use a multi-resolution cross-correlation between audio envelopes and frame-level motion-energy curves to estimate sub-frame timing offsets, and may refine the offsets using phase transform (PHAT) weighting to increase robustness under reverberation. In some embodiments, for athlete-worn systems, the alignment layer may use inertial measurement unit (IMU) impulses and jerk peaks as high-confidence anchors and may fuse those anchors with visual camera-shake metrics to correct for variable wireless transport delays. In some embodiments, this may improve the specific technology of multi-sensor stream synchronization by enabling consistent editorial timing and reducing inter-stream lip-sync errors while remaining operable across edge devices, base stations, and cloud processing architectures.

In some embodiments, a technical problem addressed by the disclosure may include that conventional shot selection pipelines may treat video-only cues as primary, thereby failing to exploit correlated evidence present in audio and telemetry, particularly in dynamic scenes where the “most relevant” viewpoint may be indicated by changes that are weakly visible but strongly audible or strongly reflected in motion/biometrics. In some embodiments, the system may improve multimodal representation learning technology by extracting modality-specific contextual features and combining them into a unified contextual representation that may preserve temporal evolution and cross-modal correspondence. In some embodiments, visual contextual features may include motion intensity measures derived from optical flow fields, subject prominence measures derived from detector confidence and bounding-box stability, and framing stability measures derived from horizon estimation or gyroscopic stabilization residuals. In some embodiments, audio contextual features may include onset strength envelopes, spectral centroid trajectories, harmonic-percussive separation features, speech activity likelihood, and crowd-reaction probability derived from a neural audio event classifier. In some embodiments, telemetry contextual features may include speed profiles, acceleration/brake events, location-derived phase-of-action estimates, biomechanical exertion indicators, and environmental context indicators such as ambient light or temperature trends. In some embodiments, the unified contextual representation may be generated via a cross-attention fusion model that may attend over temporally aligned tokens from each modality and may output a latent state sequence that is constrained to be time-consistent. In some embodiments, the fusion model may include modality-specific encoders and a shared transformer trunk, and may use learned time embeddings to represent varying frame rates. In some embodiments, the system may improve the specific technology of multimodal inference for media production by enabling editorial decisions to be grounded in jointly interpreted visual, audio, and telemetry evidence rather than any single channel.

In some embodiments, a technical problem addressed by the disclosure may include that real-time editorial control across multiple candidate streams may be unstable if selection decisions are made independently per time instant, thereby causing rapid oscillation (“camera flicker”), overly short shots, or transitions that violate cinematic pacing constraints. In some embodiments, the system may improve automated video direction technology by implementing a decision policy that may output editorial decisions as a temporally coherent sequence rather than isolated selections. In some embodiments, the decision policy may include a stateful model that may ingest the unified contextual representation and may output one or more of a current selected stream, a target future stream, and a transition schedule that may include cut points, dwell-time constraints, and transition behaviors. In some embodiments, stability may be enforced by hysteresis, wherein a new candidate stream may be required to exceed the current stream by a margin for a minimum persistence interval before a switch may occur. In some embodiments, stability may be enforced by solving a short-horizon optimization that may maximize a cumulative engagement score subject to constraints on minimum shot length, maximum cut frequency, and transition-type compatibility. In some embodiments, the decision policy may be implemented as a reinforcement learning agent trained to select cuts that maximize a proxy objective derived from human editor patterns or viewer retention signals, while a safety layer may clamp outputs to satisfy deterministic broadcast constraints such as maximum latency and bounded compute. In some embodiments, this may improve the specific technology of real-time editing control by producing coherent, watchable outputs without manual intervention during capture.

In some embodiments, a technical problem addressed by the disclosure may include that the best audio at a given moment may not be co-located with the best video viewpoint, and that naïvely binding audio and video from the same capture device may yield suboptimal intelligibility or immersion. In some embodiments, the system may improve live audio-video mixing technology by decoupling selection of a video stream from selection of an audio stream, and by generating a composed program output that may mix-and-match sources while maintaining perceptual synchronization. In some embodiments, the system may select a video stream based on visual salience while selecting an audio stream based on signal-to-noise ratio, spectral clarity, or event relevance, and may then apply time alignment and adaptive cross-fade to avoid audible discontinuities. In some embodiments, the system may perform beamforming or spatial audio reconstruction when multiple microphones are present, and may steer a virtual microphone direction based on the currently selected viewpoint or based on detected sound-source localization. In some embodiments, the system may compute an audio scene graph that may associate detected objects in video (e.g., instruments, speakers, athletes) with frequency bands and transient signatures in audio, and may use that graph to increase the gain of audio components that correspond to the visually emphasized subject, while suppressing competing components. In some embodiments, this may improve the specific technology of multimodal live production mixing by enabling higher perceived audio quality and stronger audio-visual correspondence in the directed output.

In some embodiments, a technical problem addressed by the disclosure may include that resource constraints on a mobile computing device or an on-site base station may limit the ability to perform high-fidelity analysis of many simultaneous high-bitrate camera feeds, while cloud offloading may introduce latency, bandwidth cost, and connectivity fragility. In some embodiments, the system may improve distributed edge/cloud media processing technology by partitioning the pipeline into tiers that may include capture devices, an edge coordinator (such as a phone or base station), and a cloud director service. In some embodiments, the edge coordinator may perform early-stage feature extraction and quality scoring on downsampled proxy streams, may select a candidate subset of streams for deeper analysis, and may adaptively schedule upload of either full-resolution segments or feature vectors to the cloud based on network state. In some embodiments, the system may implement a two-pass real-time architecture, wherein a first pass may generate low-latency provisional editorial decisions using lightweight models and proxy video, while a second pass may refine the decisions using higher-resolution data and may optionally regenerate a higher-quality master output for later playback. In some embodiments, the capture devices may encode dual representations, such as a high-quality base layer and a low-bitrate enhancement/proxy layer, and the edge coordinator may request enhancement layers on demand for segments that are likely to be included in the final program output. In some embodiments, this may improve the specific technology of scalable multi-stream analytics by enabling real-time direction under variable connectivity and compute budgets.

In some embodiments, a technical problem addressed by the disclosure may include that multi-camera editorial decisions may be degraded by variable per-stream quality impairments such as blur, rolling-shutter artifacts, occlusion, low light, and packet loss, and that selecting a “salient” camera may still yield an unusable output if quality is not jointly considered. In some embodiments, the system may improve video quality assessment technology for automated direction by generating per-stream quality vectors that may be evaluated jointly with contextual salience. In some embodiments, the quality vectors may include learned no-reference image quality metrics, stabilization confidence, exposure/white-balance stability, compression artifact scores, and occlusion likelihood scores derived from segmentation masks. In some embodiments, the system may compute a “compositional utility score” that may integrate salience with quality such that a stream with strong action but unacceptable blur may be rejected in favor of a slightly less salient but substantially cleaner stream. In some embodiments, the system may maintain a rolling “quality memory” per stream to prevent oscillation into a stream that recently degraded, and may use predictive modeling of quality degradation based on motion vectors and telemetry to preemptively bias away from a stream that is likely to become unstable (e.g., high vibration indicated by IMU). In some embodiments, this may improve the specific technology of automated shot selection by reducing perceptually poor selections and increasing continuity of usable footage.

In some embodiments, a technical problem addressed by the disclosure may include that generating a directed output stream in real time may require not only selecting which camera to show, but also selecting when and how to transition between cameras in a manner that is consistent with downstream playback, encoding, and streaming constraints. In some embodiments, the system may improve live program stream generation technology by generating an explicit editorial decision representation that may be applied to the underlying streams to produce a directed output. In some embodiments, the editorial decision representation may include cut points referenced to the global timeline, identifiers of selected sources, and transition parameters that may include hard cuts, dissolves, wipes, or split-screen behaviors. In some embodiments, the system may generate the directed output stream as a composed timeline with segment-level provenance and may store both the composed media and the corresponding decision metadata such that a downstream system may re-render the output at different resolutions, aspect ratios, or platform-specific formats. In some embodiments, the system may expose the decision metadata as an edit decision list-like structure or as structured event records, enabling later refinement or audit of the automated editorial outcomes. In some embodiments, this may improve the specific technology of program assembly and re-targeting by enabling consistent regeneration and post-hoc adjustments without re-analyzing raw footage.

In some embodiments, a technical problem addressed by the disclosure may include that personalization of editorial style across users, venues, or content genres may be limited by data privacy constraints and by the cost of centrally collecting raw multi-stream media for training. In some embodiments, the system may improve machine learning personalization technology by implementing federated learning for the editorial decision policy, wherein training updates may be computed on-device or on-premises using locally captured sessions and may be aggregated via secure protocols without transferring raw media. In some embodiments, the system may compute gradient updates using a local dataset of aligned multi-stream features and user feedback signals (e.g., manual overrides, replay selections, highlight saves), and may transmit encrypted model deltas that may be combined server-side via secure aggregation. In some embodiments, differential privacy noise may be added to the deltas to bound information leakage. In some embodiments, separate model heads may be trained for different content types (e.g., sports, concerts, instructional videos) and may be selected using a lightweight classifier, while a shared backbone may be updated across all devices. In some embodiments, this may improve the specific technology of privacy-preserving model training for media direction by enabling personalization and continual improvement without centralized raw video collection.

In some embodiments, a technical problem addressed by the disclosure may include that bandwidth-limited multi-stream transmission from capture devices to an edge coordinator or cloud service may constrain the number of concurrently analyzable streams and may increase latency, particularly for high-resolution or high-frame-rate feeds. In some embodiments, the system may improve video compression and transmission technology by implementing neural-assisted scalable compression tuned for editorial analytics. In some embodiments, capture devices or the edge coordinator may encode a conventional bitstream for archival quality while also generating a learned compact feature stream (e.g., latent embeddings) that may preserve motion, composition, and subject identity cues needed for shot selection. In some embodiments, the feature stream may be transmitted at substantially lower bitrate than the full video and may be used to drive editorial decisions, while the full video may be selectively fetched for only those segments chosen for the program output. In some embodiments, the system may implement region-of-interest (ROI) adaptive encoding, wherein bounding boxes for salient subjects may be allocated higher bitrate while backgrounds may be more aggressively compressed, and the ROI map may be updated based on the same visual contextual features used for shot selection. In some embodiments, this may improve the specific technology of multi-stream media transport by reducing required uplink capacity while maintaining decision quality and output fidelity.

In some embodiments, a technical problem addressed by the disclosure may include that automated editorial decisions may be difficult to explain or audit, particularly when multiple modalities contribute to a selection and when errors may arise from transient sensor faults or ambiguous scenes. In some embodiments, the system may improve explainable AI technology for media pipelines by generating per-decision rationales in machine-interpretable form. In some embodiments, the system may produce a structured explanation record that may include contributing feature attributions, such as “motion intensity increase,” “audio onset event,” “telemetry spike,” and “quality confidence,” along with associated time ranges and source identifiers. In some embodiments, feature attributions may be computed using attention-weight summaries, integrated gradients on the fusion model, or counterfactual evaluation in which candidate streams are rescored with a modality masked. In some embodiments, the explanation record may be stored alongside the editorial decision representation and may be used by a director interface to visualize why transitions occurred, enabling targeted parameter tuning without exposing raw model internals. In some embodiments, this may improve the specific technology of operational observability for automated production systems by enabling debugging, compliance review, and controlled style adjustments.

In some embodiments, a technical problem addressed by the disclosure may include that single-policy shot selection may underperform in complex scenes where multiple plausible edits exist, and that committing to one choice early may reduce robustness to uncertainty in detection, audio event classification, or telemetry noise. In some embodiments, the system may improve decision robustness technology by implementing a multi-hypothesis editorial planner that may maintain a set of candidate edit paths with associated probabilities. In some embodiments, the system may propagate multiple candidate selections forward in time using a beam search over editorial actions and may prune candidates using constraints on pacing and transition feasibility. In some embodiments, the system may delay irreversible decisions until sufficient evidence accumulates, while still producing a low-latency provisional output by selecting the highest-probability path and maintaining the ability to correct within a bounded rollback window. In some embodiments, the system may implement “soft switching” via picture-in-picture previews or brief split-screen transitions when uncertainty is high, thereby reducing the perceptual cost of an incorrect hard cut. In some embodiments, this may improve the specific technology of real-time planning under uncertainty in automated editing.

In some embodiments, a technical problem addressed by the disclosure may include that constructing coherent narrative arcs from long multi-stream sessions may require higher-level semantic understanding of scenes, participants, and event structure beyond instantaneous salience scoring. In some embodiments, the system may improve semantic scene understanding technology by incorporating a long-context narrative model that may operate over detected events and entities to shape editorial pacing and shot progression. In some embodiments, the narrative model may represent the session as a sequence of semantic events (e.g., “attempt,” “success,” “crowd reaction,” “coach instruction,” “solo,” “applause swell”) derived from multimodal classifiers, and may apply a constrained generation policy that may seek to include setup, climax, and resolution segments within target durations. In some embodiments, the narrative model may bias the cut policy to include establishing shots after scene changes, reaction shots after peak events, and continuity-preserving angles during instructional segments. In some embodiments, the narrative model may be implemented as a transformer over event tokens produced by the fusion model, and may output pacing constraints and priority weights to the lower-level cut-point selector. In some embodiments, this may improve the specific technology of automated storytelling for video production by enabling structured outputs that remain contextually coherent over longer time horizons.

In some embodiments, a technical problem addressed by the disclosure may include that privacy and rights constraints may apply to faces, voices, and identifiable telemetry, particularly in crowd-sourced live event settings where many participants contribute streams. In some embodiments, the system may improve privacy-preserving media processing technology by implementing on-device identity abstraction and selective redaction that may preserve editorial utility while reducing identifiability. In some embodiments, face and voice embeddings may be computed locally and may be converted into pseudonymous tokens used for continuity tracking (e.g., maintaining focus on the same performer) without retaining reconstructible biometric templates. In some embodiments, the system may apply reversible encryption for authorized production contexts and irreversible hashing for consumer contexts. In some embodiments, the system may perform selective blurring or neural inpainting of non-consenting bystanders while maintaining salience cues for consenting subjects, and may use consent metadata to constrain which sources may be used in the program output. In some embodiments, this may improve the specific technology of compliant automated direction in multi-party capture environments.

In some embodiments, a technical problem addressed by the disclosure may include that low-latency constraints and heterogeneous compute resources may require fine-grained scheduling of analysis workloads, and that fixed pipelines may fail when the number of active streams changes or when network conditions degrade. In some embodiments, the system may improve real-time multimedia scheduling technology by implementing a latency-aware adaptive compute orchestrator. In some embodiments, the orchestrator may monitor per-stream queue depths, decode latencies, model inference times, and uplink bandwidth, and may dynamically allocate compute budgets across streams by selecting which streams receive full inference versus lightweight scoring. In some embodiments, the orchestrator may downshift analysis resolution or frame sampling rates when constrained, and may prioritize streams that are predicted to become salient based on recent context and motion forecasting. In some embodiments, the orchestrator may enforce end-to-end deadlines for producing an output segment and may select transition behaviors that tolerate timing jitter (e.g., cuts aligned to keyframes or audio beat points) when precision switching is infeasible. In some embodiments, this may improve the specific technology of deadline-driven media analytics for live production.

Although the disclosure describes both system and method embodiments, the operations described in connection with system embodiments may be performed as method steps, and the operations described in connection with method embodiments may be implemented using system components.

Unless expressly stated otherwise, the systems and methods described herein do not require manual user intervention during operation. Editorial decisions may be determined and applied automatically by the computing device during capture of the common real-world occurrence.

Optional user input, configuration, or preference information may be incorporated in some embodiments, but such input is not required for operation of the claimed invention. The examples and embodiments described herein are provided for illustration.

What is claimed is:

1. A system for automated creative video direction, the system comprising:
a communication device configured to receive a plurality of video streams from a plurality of video capture devices and at least one of at least one audio stream and telemetry data from a telemetry data source;
a computing device communicatively coupled with the communication device, the computing device comprising one or more processors and a non-transitory computer-readable memory storing instructions that, when executed by the one or more processors, cause the computing device to:
a) process the plurality of video streams to extract a visual contextual feature associated with a common real world occurrence;
b) process at least one of the at least one audio stream to extract an audio contextual feature associated with the common real world occurrence, and the telemetry data to extract a telemetry contextual feature associated with the common real world occurrence;
c) combine the visual contextual feature with at least one of the audio contextual feature and the telemetry contextual feature to generate a unified contextual representation of the common real world occurrence;
d) determine one or more editorial decisions based on the unified contextual representation, the one or more editorial decisions comprising at least one of:
i. selecting a video stream from the plurality of video streams received in step a) for presentation,
ii. determining a time at which to transition between video streams of the plurality of video streams,
iii. selecting a camera angle associated with a selected video stream of the plurality of video streams,
iv. determining a transition behavior between successive video streams; and
v. output a directed output video stream by applying the one or more editorial decisions to the plurality of video streams.

2. A computer implemented method of automated creative video direction, the method comprising:
receiving, by a communication device, a plurality of video streams formed from visual data captured by a plurality of video capture devices from different viewpoints of a common real world occurrence;
receiving, by the communication device, at least one of at least one audio stream formed from audio data associated with the common real world occurrence, and telemetry data sensed by at least one telemetry data source associated with the common real world occurrence;
processing, by a computing device, the plurality of video streams to extract a visual contextual feature associated with the common real world occurrence;
processing, by the computing device, at least one of the at least one audio stream to extract an audio contextual feature associated with the common real world occurrence, and the telemetry data to extract a telemetry contextual feature associated with the common real world occurrence
combining, by the computing device, the visual contextual feature with at least one of the audio contextual feature and the telemetry contextual feature to generate a unified contextual representation of the common real world occurrence;
determining, by the computing device, one or more editorial decisions based on the unified contextual representation, the one or more editorial decisions comprising at least one of:
(i) selecting a video stream from the plurality of video streams for presentation,
(ii) determining a time at which to transition between video streams of the plurality of video streams,
(iii) selecting a camera angle associated with a selected video stream of the plurality of video streams,
(iv) determining a transition behavior between successive video streams; and
(v) generating a directed output video stream by applying the one or more editorial decisions to the plurality of video streams.

3. The system of claim 1, wherein the receiving of the plurality of video streams and the receiving of at least one of the at least one audio stream and the telemetry data comprises temporally aligning the plurality of video streams and at least one of the at least one audio stream and the telemetry data using time information associated with the captured data.

4. The system of claim 1, wherein the visual contextual feature is indicative of at least one of visual prominence, motion intensity, and framing stability within the plurality of video streams over time.

5. The system of claim 1, wherein the audio contextual feature is based on a variation detected within the at least one audio stream over time.

6. The system of claim 1, wherein the telemetry contextual feature is based on a change detected within the telemetry data over time.

7. The system of claim 1, wherein the combining of the visual contextual feature and at least one of the audio contextual feature and the telemetry contextual feature comprises associating the visual contextual feature and at least one of the audio contextual feature and the telemetry contextual feature based on temporal correspondence.

8. The system of claim 1, wherein the unified contextual representation reflects a change in the common real-world occurrence over time.

9. The system of claim 1, wherein the determining of the one or more editorial decisions comprises updating the one or more editorial decisions in response to a change in the unified contextual representation.

11. The system of claim 1, wherein the outputting of the directed output video stream is performed during capture of the common real-world occurrence.

12. The system of claim 1, wherein the computing device comprises at least one of a mobile device, an edge computing device, or a cloud-based computing platform.

13. The system of claim 1, further comprising a storage device configured for storing the directed output video stream for subsequent playback.

14. The method of claim 2, wherein the combining of the visual contextual feature and at least one of the audio contextual feature and the telemetry contextual feature comprises associating the visual contextual feature and at least one of the audio contextual feature and the telemetry contextual feature based on temporal correspondence.

15. The method of claim 2, wherein the determining of the one or more editorial decisions comprises updating the one or more editorial decisions in response to changes in the unified contextual representation.

16. The method of claim 2, wherein the determining of the one or more editorial decisions is performed without a manual user input during capture of the common real-world occurrence.

17. The method of claim 2, wherein the generating of the directed output video stream is performed during capture of the common real-world occurrence.

18. The method of claim 2, further comprising storing the directed output video stream for subsequent playback.

20. The method of claim 2, further comprising biasing the one or more editorial decisions using predefined user preferences while maintaining automated determination of the one or more editorial decisions.
